(19) United States
(12) Patent Application Publication
(10) Pub. No.: US 2024/0140728 A1
(43) Pub. Date: May 2, 2024

(54) FEEDER

(71) Applicant: MMD GROUP LIMITED, Laxey (GB)

(72) Inventor: Christopher PEARSON, Laxey (GB)

(73) Assignee: MMD GROUP LIMITED, Laxey (GB)

(21) Appl. No.: 18/280,893

(22) PCT Filed: Mar. 10, 2022
(86) PCT No.: PCT/GB2022/050628

§ 371 Date: Sep. 7, 2023

(30) Foreign Application Priority Data
Mar. 12, 2021 (GB) 2103455.8

(51) Int. Cl. B65G 47/42; B65G 41/00; B65G 47/18; B65G 47/51

(52) U.S. Cl. CPC B65G 47/42; B65G 41/005; B65G 47/18; B65G 47/5195; B65G 41/008; B65G 47/945

(57) ABSTRACT

A feeder (5) comprising: a feed device having: a material receiving end for receiving material; a material discharge end (11) distal of the material receiving end; an endless conveyor disposed to define a conveying surface (9) between the material receiving end and the discharge end (11) movable in use to cause material received at the material receiving end to be conveyed to the material discharge end (11), wherein the endless conveyor comprises a plurality of successively arrayed metal plates, pans or flights; a material flow monitoring device disposed in association with the feed device and adapted to obtain in use a measurement representative of a quantity of material passing along the conveying surface (9) of the endless conveyor; wherein the material flow monitoring device is adapted to obtain a measurement representative of a weight of material passing along the conveyor.

### FIELD OF THE INVENTION

This invention relates to a feeder apparatus, system and method applied to the movement of bulk material and in particular for the movement of bulk run of mine material from a working site. The invention relates in particular to a plate feeder or to a feeder based on at least some of the principles thereof. The invention relates in particular to the application of such a feeder in a system and method for handling overburden or mineral, for example for use in opencast mining. The invention relates in one example to the handling at and onward distribution from a working site of removed mineral, for example via a truck-shovel loading and distribution system.

### BACKGROUND TO THE INVENTION

In mineral operations such as open-cast mining of coal, significant volumes of heavy material need to be handled and moved, and in particular need to be handled at and distributed from the working site. For example, at a working site, typically, a large volume of material, known as overburden, has to be removed from the face and disposed of before access is gained to the minerals of interest. Then, the minerals of interest need to removed from the face and transferred for distribution for processing.

Plate feeders find wide application in the handling for transfer of volumes of heavy overburden materials or minerals. As will be familiar, plate feeders comprise conveyors in which the conveyor surface comprises and is defined by successive plates, for example overlapping and/or interlocking plates, pans or flights, for example of rolled or cast metal, that may be caused to move, for example about suitable rollers, to create a continuous conveyor surface. Plate feeders are particularly adapted to the conveyance of large and heavy product such as run of mine recovered target mineral and overburden, and other like applications that might impose an excessive mechanical burden on belt conveyors.

Hybrid feeders, in which successive flights of plates play a significant structural role in the continuous conveyor surface, but which do so in co-operation with a belt or like structure to complete the continuous conveyor surface, are also known. These may provide some of the advantages of plate feeders over belt conveyors without requiring such high tolerances in the overlapping and/or interlocking plates. Discussion herein of plate feeders will be understood to be by way of example and will not, unless the context demands it, exclude such hybrid feeders or other like feeders operating on equivalent principles.

The principal function of the plate feeder or like device is to receive material at a receiving site for example at a receiving end, in a manner which may be variable and for example batch by batch, and to deliver this at a discharge site for example at a discharge end in a manner which is more controlled and more approximately continuous. The receiving site is designed to handle high impact loads created from large run of mine material batches directly dumped onto it. Such plate feeders may also be commonly known as apron feeders, apron plate feeders, and pan feeders.

The plate feeder may be adapted at the receiving site by provision of a material receiving formation such as a hopper which acts to mitigate the shock from material batch dumped directly onto the plates and this may additionally help to facilitate its onward conveyance along the feeder in a more controlled and more continuous manner. In this way the plate feeder may be conformed to function as what is known as as a surge conveyor feeder or surge loader in that it is operable to take batch-supplied material on a receiving end, for example into the hopper, and to draw this material from the receiving end (for example, from the hopper) in a manner that approximates more closely to a continuous feed, so that it is able to discharge the same more evenly.

Used in many types of mineral and ore applications around the world, plate feeders are key to providing reliable and controlled throughput. Their use in a mineral feeding system to receive a batch load and deliver onwards in a more approximately continuous manner mitigates the impact pressure, and consequent wear, which might be experienced if feeding material directly onto a further processing unit or directly onto a belt conveyor. This primary purpose, to take material on a less controlled and for example batch basis and deliver it in a manner that is more controlled and more approximately continuous, generally mandates a robust and simple structure. While it might be desirable at some point in a material handling system to make weight or volumetric or in the case of useful mineral quality assessments, these might conventionally be done at other points in the material handling or processing system.

For large-scale overburden/mineral removal operations, use may be made of excavation machinery such as draglines as the primary load-bearing tools to move material. These machines have been developed on a huge scale. The use of shovels to load trucks for onward distribution is another commonplace method. Whilst truck-shovel loading and truck distribution is not necessarily as cost effective as dragline removal per volume of overburden or mineral removed, it offers more flexibility in removal of overburden material or mineral.

Problems associated with truck-shovel loading include those associated with ensuring that an individual truck is loaded fully and efficiently, and those associated with the essentially batch-process nature of filling discrete trucks from a shovel.

In particular, a process which requires a truck to reverse into position prior to filling, to be filled by a shovel, and then to drive out requires periodic suspension of the shoveling operation when there is no truck in place. A shovel may not be well adapted to distributing the overburden/mineral efficiently in the truck. The relatively large capacity of a shovel, say 100t, and the consequence that relatively few shovel loads that might therefore be sufficient to fill a truck, tend to make it harder to get anywhere towards 100% fill efficiencies.

Each of these factors may tend to mean that truck-shovel loading is relatively inefficient, both in terms of effectiveness of truck fill, and in terms of volume processing rates.

Some of these problems arise in particular because of the essentially batch-process nature of filling discrete trucks from a shovel. Conventional static plate feeders do not readily lend themselves to use at the working site in a truck-shovel loading and truck distribution system. WO2018/229476 describes a mobile plate feeder that is able to function as a mobile surge loader in a truck-shovel loading system and mitigate some of these disadvantages.

There is nevertheless a general desire to improve the functionality of such feeders for all applications.

In particular, it may be desirable to give additional functionality to a feeder that is or forms part of a mobile unit, for example for use at a working site.

In particular, it may be desirable to give additional functionality to a feeder that forms part of a truck loading system at a working site.

It may be further desirable to develop improved material handling and distribution methods, and for example improved methods for the handling at and onward distribution from a working site of removed mineral, for example via a truck-shovel loading and distribution system, that make use of such feeders with additional functionality. In such a context in particular, an ability to monitor more effectively the flow of material into a truck and the truck fill level might be especially desirable.

### SUMMARY OF THE INVENTION

In accordance with the invention in a first aspect, a feeder is provided for the conveyance of material, such as overburden or mineral, the feeder comprising:
a feed device having:
   a material receiving end for receiving material;
   a material discharge end distal of the material receiving end;
   an endless conveyor disposed to define a conveying surface between the material receiving end and the discharge end movable in use to cause material received at the material receiving end to be conveyed to the material discharge end,
   wherein the endless conveyor comprises a plurality of successively arrayed metal plates, pans or flights;
a material flow monitoring device disposed in association with the feed device and adapted to obtain in use a measurement representative of a quantity of material passing along the conveying surface of the endless conveyor;
wherein the material flow monitoring device is adapted to obtain at least a measurement representative of a weight of material passing along the conveyor.

The invention is thus characterized by provision, in association with a conveyor of the type comprising a plurality of successively arrayed metal plates, pans or flights, of a means to obtain at least a measurement representative of a weight of material passing along the conveyor. Providing such a capability has proved problematic in relation to prior art conveyors of this type, and represents a useful functionality, particularly in the context of determining quantities of material passing along the conveyor for example to ensure compliance with weight targets or weight limits in a system for subsequent distribution.

In example embodiments of the invention, the measurement representative of a quantity of material passing along the conveyor may be both of: a measurement representative of a volume of material passing along the conveyor; a measurement representative of a weight of material passing along the conveyor. In such embodiments, the material flow monitoring device is adapted to obtain a measurement representative of a volume of material passing along the conveyor or a measurement representative of a weight of material passing along the conveyor or both. In such embodiments, the material flow monitoring device comprises at least a means to obtain a measurement representative of a weight of material passing along the conveyor and a means to obtain a measurement representative of a volume of material passing along the conveyor.

A measurement representative of a quantity of material may be a direct measurement of the quantity, or may be a direct measurement of a secondary parameter from which the said quantity may be derived numerically from known data such as material or system constants or separately derived additional data such as endless conveyor operating speed. Means to measure such additional data such as the endless conveyor operating speed may be provided.

In optional embodiments of the invention, the feeder may include a processing module to process measured data and derive additional data numerically therefrom.

The material flow-monitoring device is disposed in association with the conveyor such as to obtain a measurement representative of a quantity of material passing along the conveyor. In continued operation the feed device may thereby be adapted to obtain progressively in real time operation a cumulative measurement representative of a quantity of material that has passed along the conveyor over a given time period, and for example a cumulative measurement representative of at least the weight and optionally additionally the volume of material, and thus, particularly if the flow monitoring device is positioned generally at or towards the discharge end, and for example thereby defines a monitoring zone generally at or towards the discharge end, to obtain progressively in real time operation a cumulative measurement representative of a quantity of material that has been discharged by the conveyor over the given time period.

An ability to monitor more effectively the flow of material, and in particular at least the weight of material and optionally additionally the volume of material, as it passes along and is discharged from the discharge end is thus provided. This potentially improves the functionality of the feeder for a range of applications where it might be desirable to quantify the material being discharged over time.

In particular, it may allow a user to obtain a measure of the quantity or rate at which material is discharged from the conveyor to a further onward transport or processing means. In addition to being useful simply as a measure of material quantity, the building of such a capacity into this class of feed device when used as a surge conveyor in a mineral conveyance/processing train may for example be used to ensure that a rate of discharge does not exceed the capacity of a continuous further onward transport means such as a long conveyor, does not exceed the capacity of a further processing means such as a mineral sizer or sorter, or to monitor the fill of a batch-by-batch further onward transport means such as a truck in a shovel-truck system.

It should be recognized that the material carried on the conveying surface of the feeder is likely to be large, heavy, and of irregular shape and density and that the feeder will require structures to accommodate this. It is in the nature of both of these things that any measurement of parameters such as flow volume or weight is difficult. Any more representative measurement of a quantity of material passing along the conveyor will be advantageous, even where a degree of approximation is made necessary by these considerations.

The material flow monitoring device is disposed in association with the feed device such as to obtain a measurement representative of a quantity of material passing along the endless conveyor in the sense that it is both suitably juxtaposed with the feed device and suitably adapted to obtain the measurement from material on the endless conveyor in use.

Typically, the material flow monitoring device is positioned in fixed relationship with the feed device to define a material flow monitoring zone such that, in use, material on the endless conveyor passes through the monitoring zone and a measurement representative of a quantity of material passing through the monitoring zone is obtained, for example progressively and cumulatively.

In preferred embodiments of the invention, the material flow monitoring device is adapted to obtain in use at least two different measurements each representative of a quantity of material passing along the endless conveyor, and for example is adapted to obtain at least both of a measurement representative of a volume of material passing along the conveyor and a measurement representative of a weight of material passing along the conveyor. In such embodiments the material flow monitoring device may comprise discrete measurement units each adapted to obtain one such measurement, for example from separate spaced monitoring zones, or additionally or alternatively may comprise multiple-function measurement units adapted to obtain more than one such measurement simultaneously and/or from a common monitoring zone.

The feed device is adapted for the handling of large and heavy mineral such as overburden or target mineral recovered at a working site. The use of metal plates, which may alternatively in the art be referred to as pans or flights, as the primary structural element of the endless conveyor surface represents a particular adaptation to this intended use for the handling of large and heavy mineral. The plates, pans or flights may for example be formed of rolled or cast metal.

In particular embodiments, the feeder comprises a plate feeder. That is to say, the endless conveyor comprises and the conveying surface is defined by the successively arrayed metal plates, pans or flights. The successive plates, pans or flights may typically be conformed as overlapping and/or interlocking to form a continuous surface. Plate feeders are particularly adapted to the conveyance of large and heavy product such as run of mine recovered target mineral and overburden, and other like applications that might impose an excessive mechanical burden on belt conveyors.

In other embodiments, the feeder may comprise a hybrid feeder, in which the successive plates, pans or flights play a significant structural role in the conveying surface of the continuous conveyor, but which do so in co-operation with a belt or like structure to complete the conveying surface. Discussion herein of plate feeders will be understood to be by way of example and will not, unless the context demands it, exclude such hybrid feeders or other like feeders operating on equivalent principles.

In some embodiments, the material flow monitoring device may be adapted to obtain a measurement of volume and a measurement of weight and derive a measurement of density numerically therefrom. In other embodiments, the material flow monitoring device may be adapted to obtain a measurement of volume and derive numerically therefrom a measurement of weight from a known or assumed density. In other embodiments, the material flow monitoring device may be adapted to obtain a measurement of weight and derive numerically therefrom a measurement of volume from a known or assumed density. All such parameters may be useful in determining progress of distribution of the flow of material from the discharge end, and for example in the case of a truck fill system obtaining an indication of truck fill level.

As will be familiar, in accordance with the principles of the invention will generally comprise an endless conveyor made up of a plurality of successively arrayed metal plates, pans or flights that are typically arranged to form a continuous loop, for example passed around rollers or the like at either end. At any given time, an uppermost surface defined by some of the plates, pans or flights thereby defines a conveying surface between the material receiving end and the discharge end. Movement of the plates, pans or flights around the continuous loop causes material received at the material receiving end to be conveyed to the material discharge end on the conveying surface. Drive engagement means are typically provided to engage the surface of the endless conveyor that lies opposed to the surface of the endless conveyor that serves to define the conveying surface. Reference may be made herein for convenience to the conveying surface as an upper surface of the endless conveyor, plate, pan or flight, and the opposed surface as a lower surface even though in the return part of the continuous loop the orientations may be reversed.

As will be familiar, a feeder in accordance with the principles of the invention will generally comprise the endless conveyor supported on a suitable support means for example including a support frame such as herein described, typically to locate the same on a ground surface. The support means is generally maintained in a stationary position during use, for example static relative to the ground surface, and the endless conveyor is caused to move relatively thereto to define a moving conveying surface and to transport material from the receiving end to the discharge end. References to stationary or static elements of the feeder or to elements being positioned statically with respect to the feeder will be understood as references for convenience to this in use generally fixed frame of reference defined by the feeder support frame, and references to movement, for example of the conveying surface and material thereon, will be understood as movement relative to that frame of reference defined by the feeder support frame. No further limitation should be inferred. In particular, as discussed in more detail herein, embodiments of the feeder may themselves be mobile.

As will be familiar, the endless conveyor defines a conveying surface uppermost in use on which material is conveyed in use and has an opposing surface lowermost in use. Reference may be made to upper and lower surfaces, to locations above and below this surface and so on. This is for convenience in explaining the relative positions of components of the feeder and no further limitation should be inferred. In particular, as discussed in more detail herein, embodiments of the feeder need not necessarily be deployed in use with the conveying surface horizontal.

In accordance with the invention, the measurement representative of a quantity of material passing along the conveyor is at least a measurement representative of a weight of material passing along the conveyor. The material flow monitoring device in such embodiments is adapted to obtain a measurement representative of a weight of material passing along the conveyor.

The measurement representative of weight may be a direct measurement of the weight, or may be a direct measurement of a secondary parameter from which the weight may be derived numerically from known data such as material or system constants or separately derived additional data such as endless conveyor operating speed. The material flow monitoring device in such embodiments may be adapted to measure the secondary parameter, and the feeder may include a processing module to process the measured secondary parameter and derive a weight numerically therefrom.

In preferred embodiments, the weight is measured directly. Thus, the flow monitoring device is adapted to obtain a measure a weight of material passing through a weighing zone defined relative to the endless conveyor progressively as material on the conveying surface of the endless conveyor is caused to move through the weighing zone.

In particular preferably, the flow monitoring device comprises a weighing system disposed below the endless conveyor (that is, on the opposite side of the endless conveyor from the side of the endless conveyor that defines the conveying surface) in a fixed relationship with the feeder, so as to define the weighing zone and so as to obtain a measure of weight of material passing over the weighing zone on the conveying surface in use.

Preferably, the weighing system is disposed adjacent to a second surface of the of the endless conveyor opposed to the conveying surface (that is, seats below the endless conveyor in the conveying region) so as to obtain a measure of weight of material passing over the weighing system on the conveying surface in use.

Preferably, the weighing system comprises an array of weighing devices such as load cells or like measurement transducers, for example mounted on a rigid frame. The frame is preferably a planar frame, for example thereby adapted to seat below and in parallel to a lower surface of the endless conveyor.

In a particularly preferred option, the weighing system comprises two frame portions disposed together for example in a generally parallel arrangement, wherein the first frame portion (uppermost in use) includes means to engage the second, lower surface of the endless conveyor, and the second frame portion (lowermost in use), carries the weighing devices disposed on the second frame portion such that a load carried by the first frame portion (and attributable to the weight of the plates and material load thereon) is transferred through and measurable by the weighing devices in use.

As will be familiar from conventional plate and hybrid conveyors to which the invention applies, and as will also be the case for embodiments of conveyor according to the first aspect of the invention, the endless conveyor is typically supported on a rigid primary support frame, typically made up of long steel beams, and a lower surface of the endless conveyor, for example being a lower surface of the carrying plates or flights is typically supported thereon to move along suitable driving engagement means for example comprising an arrangement of rollers and/or rails carried on the frame with which an undersurface of the endless conveyor engages to be translatable. For example, as will be familiar, one or more longitudinal series of rollers may be disposed to engage drivingly with a corresponding drive chain on a lower surface of the endless conveyor. For example, additionally one or more longitudinal rails may be provided as secondary supports, in typical use configured to engage the lower surface of the endless conveyor in sliding engagement, in particular in the case where it flexes under load and to limit that flexion.

The second frame portion is mountable and when the feeder is assembled is mounted on the feeder and for example on a primary support frame of the feeder, for example in fixed mechanical arrangement with the primary support frame, for example engaged upon it or conformed as a part of it. Preferably, the second frame portion is mounted to be carried by the primary support frame but is carried spaced above a lower body portion of the support frame. For example the second frame portion may be bolted, pinned or otherwise mounted to side portions of the primary support frame so as to sit slightly spaced above the lower body portion of the support frame.

The first frame portion is seated upon the second frame portion, but is in the preferred case not mounted in fixed manner to the feeder, being free to move at least to the extent necessary to transmit load to the weighing devices on the first frame portion.

As noted, the feeder comprises drive means to drive the endless conveyor in use. For example, in a typical arrangement, the feeder comprises a primary support frame including engagement means on the primary support frame such that the endless conveyor engages to be translatable thereon. For example, the primary support frame comprises one or more longitudinal series of rotational drive engagement formations such as rollers, cogs or wheels, disposed to engage drivingly with a corresponding drive means such as a drive belt or chain on a lower surface of the endless conveyor.

Preferably the first frame portion is provided with compatible and for example identical engagement means configured to co-operate with the engagement means on the support frame such that with the weighing system in position the endless conveyor engages to be translatable continuously thereon. For example the first frame portion is provided with rotational drive engagement formations configured to co-operate with equivalent rotational drive engagement formations on the support frame such that with the weighing system in position the endless conveyor engages to be translatable continuously thereon, and for example configured to align with equivalent rotational drive engagement formations on the support frame. For example, additionally or alternatively, the primary support frame comprises one or more longitudinal rail formations and the first frame portion is provided with rail engagement formations configured to align therewith.

As the endless conveyor is driven and carries a load, the first frame portion thus engages a lower surface of the endless conveyor via the engagement means and the entire load carried by and through the first frame portion thereby passes through and is measurable by the weighing devices.

Thus, the load carried by the second frame portion and transmitted through the weighing devices is that of the local mass of the first frame portion, any associated plates or flights, other structure such as side walls and, when in use carrying material, the mass of the material as well. This arrangement allows ready meaningful determination of the weight of material supported upon the conveyor surface in the region of the two plate portions by subtracting the laden weight at any time from a predetermined unladen weight.

The two part frame structure is particularly effective as it means that the load that is being measured at the load cells is largely independent of how the mineral is distributed, and uneven distributions and distributions partly supported on or against the side walls can be accommodated in a manner that would not be possible with known belt-based weighing systems.

The weighing devices are arranged in a distributed array across a weighing area, for example being the area defined by a rigid frame, such as the first frame portion/second frame portion arrangement above described. For example the array is a polygonal array, and for example the frame defines a polygonal load cell support structure, with a weighing device such as a load cell at each vertex. Most preferably, the array is a triangular array, and for example the frame defines a triangular load cell support structure, with a weighing device at or about each vertex.

The conveying surface is not necessarily horizontal in use. In embodiments or for particular applications, the discharge end may be at a different height to the receiving end. In particular conditions, the conveying surface may not be transversely level. To accommodate this, the weighing devices are preferably mounted to vary orientation relative to the static frame of the feeder and maintain in use an orientation that is maintained relative to the vertical such that the load to be measured is measured in a vertical orientation rather than normal to the angle of the conveying surface.

In accordance with the above, a system is provided that may provide for in-line weighing of material on the conveying surface progressively and cumulatively that is suitable for conveyors of the plate type.

Known techniques for the in-line weighing of material on belt conveyors are not readily applied to conveyors of the plate type where the primary structural element of the belt is a rigid metal plate and where the conveyed material is heavy mineral or overburden.

For example, in mining production, it is known to measure weight in-line at the transport stage on the transport conveyor, which may be a belt conveyor. Usually this is to obtain a product production rate assessed in terms of mass flow rate per time, (typical tonnes/hour, or Kg/second). This rate is normally measured on a belt weigher. The reading of the load on a conveyor belt is measured through rollers with a means of measurement of the applied load. This is convenient because the conveyor rubber belting is typically light, and the material has had some processing by this time, (crushing or sizing) to make it suitable for conveyor transport, and the measurement means is convenient. Many such units are available. Usually and in practice these kinds of belt scale do not give a high level of accuracy, and their main use is to give a broad assessment of mine production. Such systems do not work in conjunction with a plate conveyor carrying unprocessed run-of mine material.

The ability to measure weight in-line in real time on a plate feeder might be useful for many reasons and in many applications but presents many challenges. A plate feeder is wide, and can be 3 m. The material being transported can sit all at one side. The general disposition is random. The plate feeder may be on an angle, in two planes, especially in the case of mobile systems. The weight of material carried is very large, and can be in the typical order of 16 tonne per metre length of the feeder. The carrying plates have a long span, and they are made from alloy steel, of some 75 mm thickness, and over 3 m long, they are heavy rugged components. They are not particularly precision.

The weighing system herein described overcomes these challenges and allows a practically useful measurement of weight to be obtained from the in-line flow, progressively and in real time on feeders of the plate type even with heavy unprocessed run of mine material.

In preferred embodiments, the measurement of weight may be combined with knowledge of or a measurement of the speed of movement of the endless conveyor to determine a mass flow rate. Suitable means to measure the speed of movement of the endless conveyor may be provided.

The feeder may comprise a processing module adapted to process the measured weight and derive a mass flow numerically therefrom using a known or measured speed of movement of the endless conveyor.

Neither weight nor mass flow measurement has been done before on a plate feeder. Neither has either been done directly with run of mine material on a mine face. The approach above described makes both of these things practical.

The ability to measure weight and mass flow accurately on a plate feeder might be useful for many reasons and in many applications. In particular in respect of processes where the plate feeder is used to transfer between two batch processes, such as the truck fill system exemplified herein, accurate knowledge of weight passing on the feeder contributes to accurate fill.

Preferably, embodiments of the feeder of the invention provided with a weighing capability are additionally provided with a system to measure volume flow. The volume flow measurement system in conjunction with the weighing system enable the user to measure the mass per cubic meter that is being conveyed, and for example where the feeder is being used in a truck load system, the mass per cubic meter that is being loaded to each haul truck.

Such a volume flow measurement system may be in accordance with the embodiments described herein, and advantageous features of embodiments of volume flow measurement systems described herein and weighing systems described herein may be combined as desired to the extent that is technically feasible to provide feeders in accordance with the principles of the invention.

In some embodiments of the invention, a further measurement representative of a quantity of material passing along the conveyor is a measurement representative of a volume of material passing along the conveyor. The material flow monitoring device in such embodiments is adapted to obtain a measurement representative of a volume of material passing along the conveyor.

The measurement representative of volume may be a direct measurement of the volume, or may be a direct measurement of a secondary parameter from which the volume be derived numerically from known data such as material or system constants or separately derived additional data such as endless conveyor operating speed. The material flow monitoring device in such embodiments may be adapted to measure the secondary parameter, and the feeder may include a processing module to process the measured secondary parameter and derive a volume numerically therefrom.

In a particular example, the flow monitoring device is adapted to obtain a measure an area of material passing through a monitoring plane (defined perpendicularly relative to the endless conveyor surface and travel direction) progressively as material on the conveying surface of the endless conveyor is caused to move through the monitoring plane in the travel direction in use, and the feeder is adapted to process the progressive measurements of area with a speed of the conveyor to derive a measurement of volume therefrom.

To achieve this, the flow monitoring device is adapted to obtain a measurement of a height of material at a plurality of points extending transversely across the endless conveyor as material on the conveying surface of the endless conveyor is caused to move through the monitoring plane and to derive an area therefrom. For example, the processing module is adapted to process the measured heights and derive an area numerically therefrom.

Thus, the flow monitoring device comprises a material sensor system positioned statically with respect to the feed device so as to define a monitoring plane and so as to measure a material height at a plurality of points extending transversely across the endless conveyor as material on the conveying surface of the endless conveyor is caused to move through the monitoring plane in use and derive an area from these multiple heights.

In particular in the preferred case the material sensor system comprises one or more height sensors to sense a height of material above the conveying surface at a plurality of points extending transversely across the endless conveyor. A measurement representative of the area of material may be derived therefrom by any method that gives an acceptable level of accuracy. Multiple heights are measured at multiple positions spread across the conveyor width to build up a more accurate picture of area distribution of material.

In a preferred case the one or more sensors are carried in static position above the conveying surface, for example on a suitable transverse support, to measure a distance to the top of material at the said multiple positions across the conveyor width and to derive therefrom a height at each said point. Such a derivation involves a calculation of the difference between a known and fixed distance from the sensor to the belt and a measured distance from the sensor and the top of the material at the said multiple positions, subject to appropriate corrections if any for the geometry. An approximation of area may be calculated from these multiple heights, and a measure of volume may be obtained by repeating the determination of such an area successively.

In a preferred case the height sensor system comprises one or more reflected light sensors, and for example on or more laser distance sensors, configured to measure a height of material above the conveying surface at a plurality of points extending transversely across the endless conveyor.

Thus, in such case, plural heights spaced across the width of the endless conveyor are determined by directing a light beam from the reflected light sensor(s) towards a plurality of positions on the endless conveyor surface spaced transversely across the surface and by measuring a distance to the top of material in each beam direction to derive therefrom a height at each said point.

In a possible embodiment, plural light sources may be spaced apart above the surface of the endless conveyor to deliver light beams in a linear array and for example be directed downwardly normal to the surface.

However in an alternative embodiment, a consolidated light source arrangement is provided delivering an angular array of light beams directed downwardly towards the surface. Such an arrangement, with the consolidated light source arrangement preferably mounted generally above a longitudinal mid line of the conveying surface, for example on a suitable transverse support, and thus between and away from any side walls, deals admirably with the potential problems created by those side walls to conventional sensor arrangements. The plural beams each measure a distance to the top of material in each beam direction. To derive therefrom a height at each said point does require appropriate but trivial geometric correction to take account of the angular direction of each beam.

Preferably a large plurality of angularly spaced beams is provided, for example no more than one degree apart from each other and with a spread of at least 150 degrees, and preferably in an evenly spaced and symmetrical array. Large numbers of measurements enable an accurate measure of area to be obtained from a single consolidated light source arrangement.

Thus, a measurement representative of an area at a given instance may be determined. From this any suitable methodology may be used to determine a volume or a volume flow. For example, the processing module may be adapted to process the determined area and derive a volume or volume flow numerically therefrom using other known or measured parameters.

For example, the conveying speed of the feeder is known or readily measurable. In a particular preferred case, the measurements above described may be combined with a measurement of the speed of movement of the endless conveyor to determine a volume flow rate. Suitable means to measure the speed of movement of the endless conveyor may be provided. The processing module may be adapted to process the determined area and derive a volume flow numerically therefrom using a known or measured speed of movement of the endless conveyor.

For example, from a measurement of area, the method of determining volume flow comprises measuring the depth of material and multiply by the span of that material passing through the measuring plane to determine the material area (ΔA). This determined area (ΔA) is then multiply by the speed of the feeder (S) to determine the volume flow (V) at that point in time in cubic meters.

Volume Flow V=ΔA×S

Known techniques of volume flow measurement in belt conveyors are not readily applied to conveyors of the plate type. In a typical belt conveyor through the roller arrangement it is possible to carry and balance the conveyed material in the middle of the belt. This makes it possible to have a more accurate volume flow measurement on such system. It is much harder to achieve this effect where the primary structural element of the belt is a rigid metal plate and where the conveyed material is heavy mineral or overburden. The material tends to spread to the edges.

Moreover, for the same reasons, conveyors of the plate type will typically be provided with side walls on either side of the endless conveyor for at least some of the length of the conveying surface. This is particularly likely to be necessary in cases where the discharge end is elevated. Solutions achieved on a horizontal run belt cannot readily be applied. Solutions achieved on a system without side walls cannot readily be applied. The existence of side walls makes volume measurement challenging and give false readings. Plate feeders can carry material on the sides and there is no mechanism to convey or arrange material flow in the middle section as can be done with belt conveyor.

For this reason, in preferred embodiments, the flow monitoring device comprises a material sensor system positioned statically with respect to the feed device in a fixed position above the conveying surface of the endless conveyor, for example on at least a cross member of a rectangular support mounted to a support frame of the feed device. In embodiments, the feed device comprises parallel side walls on either side of the endless conveyor for at least some of the length of the conveying surface and the cross member is positioned above the height of the parallel side walls.

The innovative approach of the structural embodiments and algorithm described above mitigate these difficulties. The algorithm in effect takes cognizance of the walls. This measure volume flow irrespective of the material deposit location on the feeder.

Material volume flow measurement has not been done before on a plate feeder. Neither has volume flow measurement been done before on a mine face. The approach above described makes both of these things practical.

The ability to measure volume and volume flow accurately on a plate feeder might be useful for many reasons and in many applications. In particular in respect of processes where the plate feeder is used to transfer between two batch processes, such as the truck fill system exemplified herein, accurate knowledge of volume passing on the feeder contributes to accurate fill.

Preferably, embodiments of the feeder of the invention provided with a volume flow measurement capability are additionally provided with a weighing system to measure weight. The volume flow measurement in conjunction with the weighing system enable the user to measure the mass per cubic meter that is being conveyed, and for example where the feeder is being used in a truck load system, the mass per cubic meter that is being loaded into each haul truck.

Such a weighing system may be in accordance with the embodiments described herein, and advantageous features of embodiments of volume flow measurement systems described herein and weighing systems described herein may be combined as desired to the extent that is technically feasible to provide feeders in accordance with the principles of the invention.

In some embodiments, the feeder may include a material scanner from which an indication of composition may be obtained, and for example further from which inferences may be drawn about material density, ore quality or other material property.

In some embodiments, the discharge end and the receiving end may be at different heights. For example the discharge end may be elevated relative to the receiving end. The feeder may be adapted to raise and lower the discharge end relative to the receiving end.

In some embodiments, the feeder may include side walls on either side of the endless conveyor for at least some of the length of the conveying surface thereof to prevent material from spreading beyond the edges of the conveying surface.

Preferably, the feed device comprises a support frame on which the endless conveyor is supported to be movable in use to cause material received at the material receiving end to be conveyed to the material discharge end.

In such embodiments, the material flow monitoring device may be positioned and for example engaged mechanically in a fixed relationship with the support frame, for example to define a material flow monitoring zone as herein described.

The support frame may additionally include or be mechanically engaged with ground support means to locate the feed device and feeder stably on a ground surface in use.

In some embodiments, the feed device may include one or more rollers at either or both of the material receiving end or the material discharge end about which the endless conveyor may be caused to be driven in use to cause material received at the material receiving end to be conveyed to the material discharge end. For example one or more of the said rollers may be driven rollers. Additionally or alternatively one or more of the said rollers may be freely rotatable to support the endless conveyor as it is caused to be driven in use to cause material received at the material receiving end to be conveyed to the material discharge end. The one or more rollers may be mounted for rotation on a support frame as above described.

The material receiving end of the feed device optionally comprises a material receiving hopper. The material receiving hopper facilitates the more even distribution of batch loads of material from the material receiving end onto the conveying surface so that it may be conveyed to the discharge end in a closer approximation to a continuous flow.

The feeder is thus conformed as a surge conveyor feeder in that it is operable to take batch-supplied material on the receiving end, for example into the hopper, and to draw this material from the receiving end (for example, from the hopper) in a manner that approximates more closely to a continuous feed, so that it is able to discharge the same more evenly at the discharge end.

As will be appreciated, while this more continuous discharge is maintained when the conveyor is in operation as a surge conveyor, it is not necessary that the conveyor must be used as part of a continuous onward supply system. A surge conveyor, by its nature, conveys material from the batch input in a more approximately continuous manner to the discharge end to supply into an onward distribution system. However, the onward distribution need not be a continuous process.

Indeed, in the embodiment discussed below, where the feeder is used to load successive trucks, it is inherently being used in a batch load in, batch load onwards process. The feeder will discharge material at the discharge end, in a generally continuous manner, until a truck is loaded, and may then stop operation while the truck is driven away and a new truck brought into place.

In possible embodiments, the feeder is mobile, in the sense that it is movable from place to place. In practice, in use with the conveyor of the feed device in operation, the feeder will be held static, but is adapted to be movable from the working site to another working site between operations. Such a mobile option may be particularly useful and confer particular flexibility if the feeder of the invention is to be deployed to work with run of mine material at a working site

In such embodiments the feeder preferably further comprises:
a chassis supporting the feed device;
a transport carriage supporting the chassis and adapted to cause the feeder to be movable across a surface for deployment in use.

The transport carriage in a possible embodiment includes one or more ground contactable transport arrangements adapted to effect movement of the feeder across a ground surface in use. For example the transport carriage may include a pair of parallel, driven, ground-engaging tracks.

In a possible embodiment the transport carriage may include a pair of parallel, separately driven ground-engaging tracks and one or more control devices for selectively driving the respective said tracks at different speeds so as to effect steering of the transport carriage.

In a possible embodiment the chassis may be rotatably supported on the transport carriage to permit rotation of the chassis and feeder thereon relative to the transport carriage.

In an intended application of the feeder of the first aspect of the invention in the context of the movement of material such as overburden or mineral at a working site, the intention is that the feeder in accordance with the first aspect of the invention may be positioned to receive such at the receiving end, and an onward distribution means may be provided which is supplied by material such as overburden or mineral from the material discharge end.

In a preferred example the onward distribution means may be a transport truck and the feeder may serve to facilitate more efficient material handling in a truck-shovel loading system through the provision of a more effective measurement by the feeder of a parameter representative of a quantity of material being conveyed through the measuring zone and then loaded onto the truck.

For example using truck-shovel loading principles, in which overburden or mineral is recovered at the working site by the shovel to be loaded shovel load by shovel load into a truck for onward transportation the intention is that the feeder in accordance with the first aspect of the invention sits between the shovel and the truck, which is then supplied by material such as overburden or mineral from the material discharge end of the feeder.

Thus, in accordance with the invention in a second aspect, a method for the movement of material such as overburden or mineral from a working site comprises: providing a feeder in accordance with the first aspect of the invention positioned to receive material from a work front at a working site;
picking up material from the work front;
transferring material to the material receiving end of the feeder;
conveying material to the discharge end of the feeder.

The step of transferring material to the material receiving end of the feeder may be performed directly by the shovel, in that the shovel is operable to transfer material directly to the material receiving end of the feeder. Alternatively, the shovel may be operable to transfer the material directly to secondary apparatus that is configured and positioned to pass the material, for example after processing, to transfer material to the material receiving end of the feeder.

More specifically the method may comprise:
providing a material shovel at a work front of the working site;
moving the feeder into position with the material receiving end positioned to receive material from the material shovel;
positioning an onward transport means to receive material from the material discharge end of the feed device;
picking up material from the work front using the bucket of a material shovel; transferring material from the bucket of the material shovel to the material receiving end;
conveying material to the discharge end of the feeder and thereby to the onward transport means.

The onward transport means may be any suitable continuous or batch transport means including conveyors such as belt conveyors such as transport conveyors, transport volumes of trucks and the like, railway carriages and the like etc. In a particularly preferred embodiment, as noted, the method is embodied in a truck loading system, and the transport means is a successive series of transport trucks.

Thus, more specifically the method may comprise:
providing a material shovel at a work front of the working site;
moving the feeder into position with the material receiving end positioned to receive material from the material shovel;
positioning a transport truck including a material transport volume to receive material from the material discharge end of the feed device;
picking up material from the work front using the bucket of a material shovel; transferring material from the bucket of the material shovel to the material receiving end;
conveying material to the discharge end of the feeder and thereby into the material transport volume of the truck.

In operation, trucks with empty transport volumes are driven successively into position at the discharge end and successively filled.

Similarly, in accordance with the invention in a third aspect, a system for the movement of material such as overburden or mineral from a working site comprises: a material shovel having a bucket adapted to pick up material and move the material from a work front;
a feeder in accordance with the first aspect of the invention positioned to receive material at the material receiving end, for example discharged directly from the bucket or discharged from secondary apparatus to be supplied by material discharged directly from the bucket, and to convey the same to the material discharge end;
a transport truck including a material transport volume positioned to receive material from the material discharge end of the feed device.

Similarly, in accordance with the invention in a fourth aspect, there is provided the use of a feeder in accordance with the first aspect of the invention to supply and load a material onward transport means as herein described, which in the preferred case is a material transport volume of a transport truck, for example as part of a shovel-truck loading system at a working site.

The feeder may thus facilitate more efficient truck loading in a truck-shovel loading system through the provision of a more effective measurement by the feeder of a parameter representative of a quantity of material being conveyed through the measuring zone and then loaded onto the truck.

Thus, the system of the third aspect of the invention is a system for putting into operation of embodiments of methods of the second aspect, the method of the second aspect of the invention is a method of use of embodiments of methods of the third aspect, and the system and method both make employ embodiments of a feeder in accordance with the first aspect of the invention in a use in accordance with the fourth aspect. Preferred features of embodiments of each aspect described herein will be understood to apply to other aspects by analogy.

The feeder in accordance with the first aspect of the invention may be particularly useful in operation of the method of the second aspect of the invention and as part of a system of the third aspect for more efficient material handling at a working site in particular with heavy run of mine material. Advantages of operation may accrue through the provision of a more effective measurement by the feeder of a parameter representative of a quantity of material being conveyed through the measuring zone for onward supply. Particular advantages of operation may accrue where the feeder is used to give a surge loader capability. Particular advantages of operation may accrue where the feeder is mobile and can be moved about the working site.

Advantageously further, the combination of a material receiving end, particularly if combined with a receiving hopper, and an endless conveyor to cause material received at the material receiving end/hopper to be conveyed to the material discharge end means that the feeder is able to function as a surge conveyor. As a result, discrete batch supply from the shovel at the hopper may be converted to a more even continuous supply at the discharge end. This facilitates more even loading of the truck, and makes it more likely that load levels of nearer 100% can be achieved. Additionally, subject to appropriate capacity design for the hopper, it may be possible to continue to supply the hopper via the shovel whether a truck is immediately in place or not, increasing overall throughput volumes.

It should be noted that this should not be read to imply that the feeder in functioning as surge conveyor should only be operated continuously when it is being used in an inherently shovel batch load in, truck batch load onwards process. The feeder will discharge material at the discharge end, in a generally continuous manner, until a truck is loaded, but may then stop operation while the truck is driven away and a new truck brought into place. Thus, the feeder in this mode of operation in effect acts as a buffer between a batch input (shovel load by shovel load) and a batch distribution (truck load by truck load).

Advantageously further in the case of mobile embodiments, the transport carriage supporting the chassis on which the feed device itself sits makes the feeder mobile, so that it can be brought into and out of a desired operational position as required, co-operating with the movement of the operational front and the movement of the trucks to improve operational efficiency.

The key to all aspects of the invention as applied to the truck loading system is the provision of the feeder between the shovel and the truck, and in particular the provision of the feeder so as to load the truck directly from the discharge end while obtaining a cumulative real time measurement of material quantity being loaded, and in the preferred case some or all of weight, volume, mass flow, volume flow and density of material being loaded. This facilitates more efficient loading of the truck, and makes it more likely that load levels of nearer 100% can be achieved. For example fill levels of more than 90% and more preferably at least 95-98% are achievable, which is not typically achievable by batch filling using conventional shovel fill protocols.

In possible embodiments, processing capacity of the feeder may be designed, for example via provision of a hopper of suitable capacity, to be such relative to the cycle time of the shovel that the shovel operator cannot overwhelm it, allowing for effectively continuous operation of the shovel.

Subject to provision of this feeder in accordance with the first aspect of the invention for use between the shovel and the truck in a method and system of the second and third aspects of the invention, the shovel and the truck themselves may be of conventional known design.

In a preferred embodiment of the method of the second aspect, or a preferred embodiment of the system of the third aspect, the material receiving end of the feed device may be positioned to be supplied and may be supplied with material such as overburden/mineral directly from the shovel. The material discharge end of the feed device may be positioned to supply and may supply material such as overburden/mineral directly to a truck.

Alternatively supply of material such as overburden from the shovel to the receiving end of the feed device and/or supply of material such as overburden/mineral from the discharge end of the feed device to a truck may be indirect in the sense that it passes via intermediate equipment.

The feeder is preferably adapted for use as a mobile unit, and for example is provided with a chassis supporting the feed device and a transport carriage supporting the chassis as above described and thereby adapted to cause the feeder to be movable across a surface for deployment in use. The feeder may thus be deployed in use into optimum location, and is for example movable about a working site, although it will generally be stationary in operation. This may allow for more efficient operation at a working site for example in a truck-shovel loading protocol.

Where a mobile feeder is used in a truck-shovel loading protocol the shovel is preferably also mobile. For example the shovel may include a mounting chassis, transport carriage and drive arrangement by analogy to that provided in embodiments of the feeder described herein.

A system in accordance with the third aspect of the invention may additionally include a sensor system to sense fill level as a truck is filled. However it is an advantage of the feeder in accordance with the first aspect of the invention that it may itself obtain a measurement of material flow from which a fill level may be derived as a truck is filled.

In either case, there may be further provided a conveyor control system to cause the conveyor of the feeder device to pause when a truck is detected as being full, allowing an empty truck to be positioned in replacement. The processing capacity of the receiving end of the feeder is preferably such as to allow for continuous operation of the shovel during this period. For example a suitable hopper is provided at the receiving end.

A system in accordance with the third aspect of the invention may also include a sensor system to sense distribution of load within the truck. Conveniently such a sensor system is adapted co-operably with a conveyor control system to cause the conveyor of the feeder device to distribute material more evenly into a transport volume of the truck.

The use of sensors may have advantage in some cases for example in facilitating the automation of the process. However in a possible alternative mode of operation manual signaling may be used as an alternative to sensors to monitor fill levels and fill distributions.

### BRIEF DESCRIPTION OF THE DRAWINGS

The invention will now be described by way of example only with reference to the accompanying drawings in which:

FIG. 1 is a diagrammatic side elevation of a feeder which may be provided in accordance with an embodiment of the first aspect of the invention in an example use with other apparatus in a truck-shovel loading and distribution system so as thereby to constitute an embodiment of the system of the third aspect of the invention and illustrative of an embodiment of the method of the second aspect of the invention;

FIG. 2 is a diagrammatic side elevation of an example use with an alternative arrangement of other apparatus thereby constituting an alternative embodiment of the system of the third aspect of the invention and illustrative of an alternative embodiment of the method of the second aspect of the invention;

FIG. 3 is a diagrammatic side elevation of a feeder provided with a weighing system and volume measurement system in accordance with an embodiment of a first aspect of the invention;

FIG. 4 is a perspective view of a feed device such as would be incorporated into the feeder according of FIG. 3;

FIG. 5 shows in side elevation the feed device of FIG. 4 with the weighing system fitted;

FIGS. 6A to 6F show various features of the weighing system;

FIGS. 7A and 7B show the weighing system in situ within the feed device;

FIG. 8 shows a suitable sensor for use in the volume measurement system.

### DETAILED DESCRIPTION OF PREFERRED EMBODIMENTS

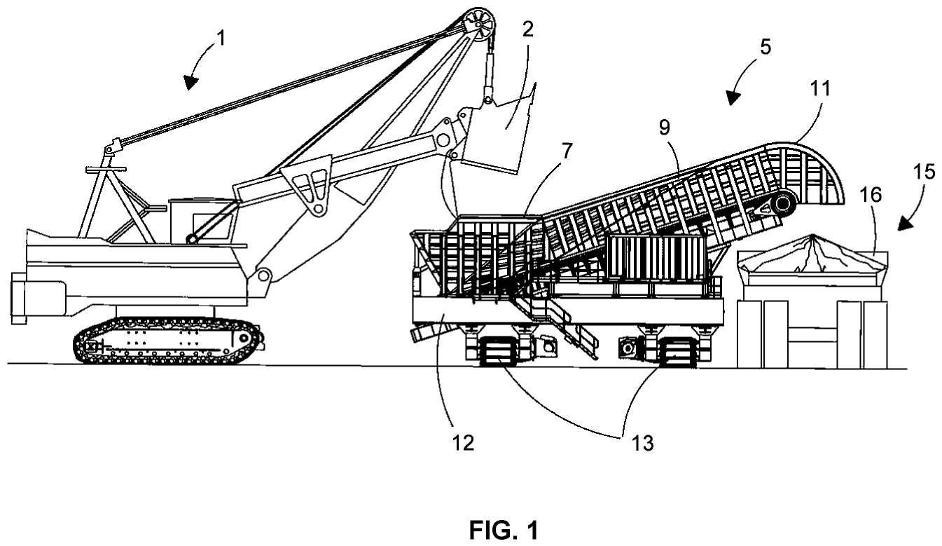

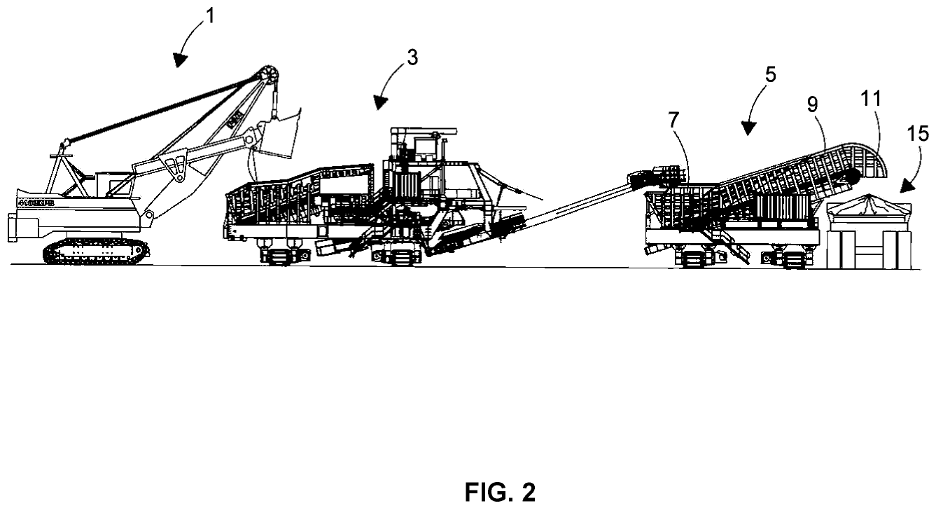

FIGS. 1 and 2 illustrate a mobile embodiment of a feeder 5 shown schematically and without detail of the measurement system, in order to illustrate an example use to which the feeder of the first aspect of the invention may be put in a truck-shovel loading and distribution system for run of mine material at a working site.

WO2018/229476 describes the use of a mobile plate feeder that is able to function as a mobile surge loader in a truck-shovel loading system such as is illustrated in FIGS. 1 and 2.

We discuss below the operation of such a truck-shovel loading system in the generality and then discuss the particular advantages that accrue in the use of a feeder in accordance with the principles of the invention as the feeder 5 of FIGS. 1 and 2, with a capability of measurement by the feeder of a parameter representative of a quantity of material being conveyed through the measuring zone for onward supply to the truck.

Advantages of operation accrue thereby in giving a capacity to determine directly from the feeder information about the fill level of the truck. In the described embodiment the feeder 5 is configured as a mobile surge loader. Particular advantages of operation may accrue as discussed in this example mode of use where the feeder of the first aspect of the invention is used to give a surge loader capability and where the feeder is mobile and can be moved about the working site.

In the illustration in FIG. 1, a possible truck-shovel loading system is shown. A mobile shovel 1, mobile surge feeder 5 constituting a possible embodiment of the first aspect of the invention, and a truck 15 are shown positioned left to right in series. A typical mobile shovel 1 and truck 15 are shown, but the system may employ any suitable known or adapted designs of shovel and truck without departing from the principles of the invention.

In the FIG. 2 arrangement an additional optional piece of equipment constituting a mobile mineral sizer 3 is disposed between the shovel 1 and receiving hopper 7 and a receiving end of the surge feeder 5. Otherwise the apparatus in the illustrated embodiment is the same as in FIG. 1 and like reference numerals are used.

Other alternative additional processing apparatus may be positioned here or else where within the system without departing from the principles of the invention, or such additional processing apparatus may be dispensed with altogether as shown in FIG. 1.

On operation of a suitable truck fill protocol, overburden/mineral material is removed by the shovel 1 in conventional manner. In the illustrated embodiment of FIG. 1 it is passed directly to the surge feeder 5 from the bucket 2 of the mobile shovel 1 directly to the hopper 7 of the surge feeder 5. In the illustrated embodiment of FIG. 2 it is passed indirectly to the surge feeder 5, in that it is first provided to the mobile sizer apparatus 3 for initial processing.

In either mode of operation, overburden/mineral material is supplied by the shovel, directly or indirectly, to the hopper 7 in the receiving region of the feeder 5. It is conveyed via the conveying surface 9 formed by a successive series of steel plates to a discharge end 11 where a truck 15 waits to receive it into its load volume 16.

The feeder is mobile, by virtue of being mounted on a chassis 12 and provided with parallel ground engaging tracks 13.

The shovel and the truck may be of generally conventional design. Open cast mining operations are constantly seeking more flexible solutions to match truck and shovel capacities and processing rates and to improve fill level accuracy and efficiency in particular. In direct loading systems, where a shovel such as illustrated in the embodiment loads a truck directly batch by batch, trucks rarely reach 90% load and load rates of say 6000 tons per hour might be typical where a shovel might in principle have a capacity of 10000 tons per hour because of delays as each truck is replace. The surge feeder of the invention provides an admirable solution.

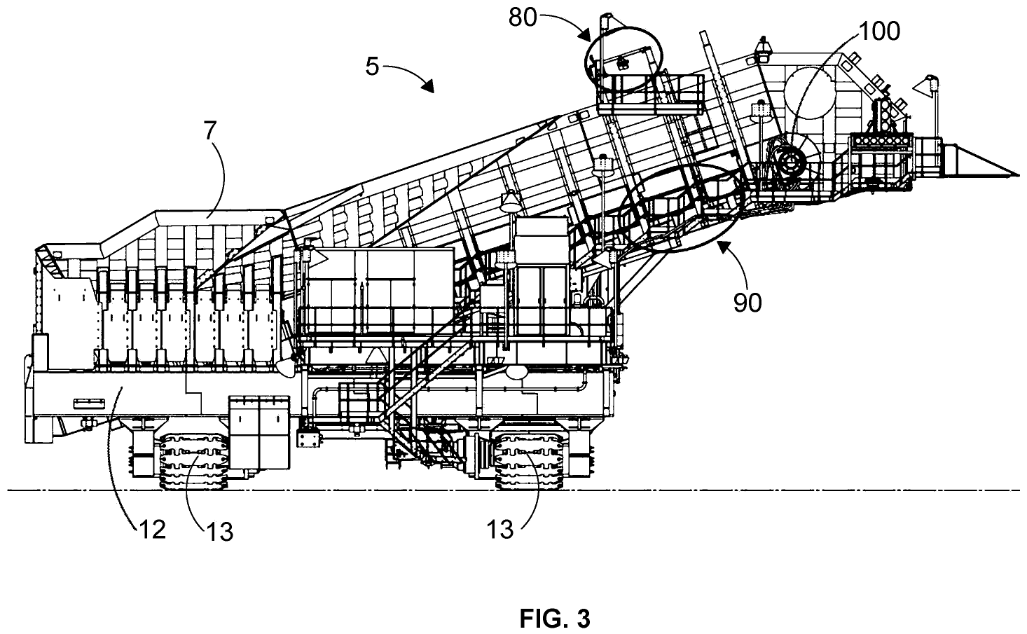

To adapt a system such as that of FIGS. 1 and 2 to the principles of the invention, the feeder 5 may be adapted by the provision of a monitoring zone see FIG. 3 for example) provided with one or more flow monitoring devices each adapted to obtain a measurement representative of a quantity of material passing along the endless conveyor. This allows the feeder 5 to obtain progressively in real time operation a cumulative measurement representative of a quantity of material that has been discharged by the conveyor over the given time period and thus a cumulative measurement representative of a quantity of material that has been discharged into the truck fill volume.

The main advantage of the use of a feeder in accordance with the invention in a system such as that exemplified in FIGS. 1 and 2 is the ability to use the flow measurement capability as a means of monitoring truck fill level, whether in isolation or in conjunction with other systems such as cameras, fill sensors in the truck, visual observation etc. Better use of fill capacity is likely to be achievable. Improved automation is likely to be achievable.

Examples of material flow monitoring device which may be provided on the feeder 5 whereby it is adapted to obtain in use a measurement representative of a quantity of material passing along the endless conveyor of the feeder are discussed with reference to FIGS. 3 to 8. By way of example, flow monitoring devices to determine a volume flow and a weight of material are discussed.

These may conveniently be provided positioned generally at or towards to the discharge end at the monitoring zone (eg located as the weighing system and volume scanner of FIG. 3) to obtain progressively in real time operation a cumulative measurement representative of a quantity of material that has been discharged by the conveyor into the truck over the given time period.

FIG. 3 illustrates in side elevation an embodiment of a feeder apparatus in accordance with a first aspect of the invention, which is conformed as a mobile surge loader and is provided with a weighing system generally denoted 90 and a volume scanning system generally denoted 80.

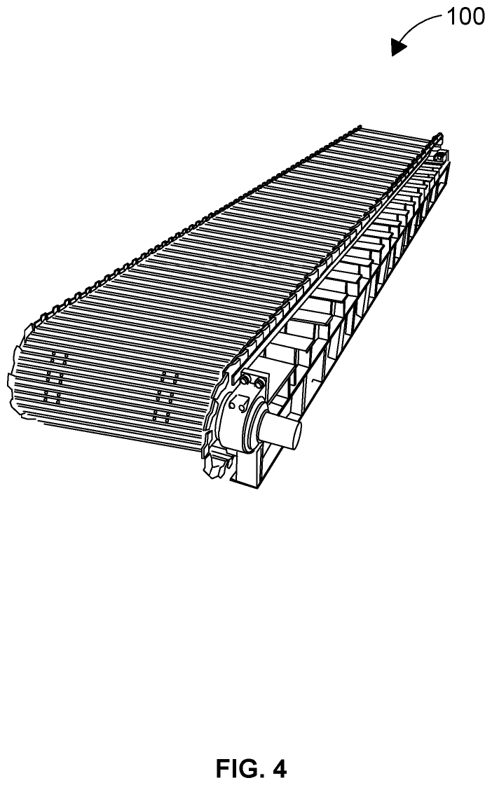

The mobile feeder shown in the FIG. 3 embodiment includes a feed device comprising an apron plate feeder 100 as illustrated in isolation in perspective view in FIG. 4.

As will be familiar, the apron plate feeder 100 comprises a series of successively arrayed steel plates, which together constitute a conveying surface, and which are carried and driven for rotation about rollers mounted on a suitable frame. In the illustrated embodiment, rolled plate flights are used. Alternatively, cast or fabricated plate flights may be used. In the embodiment, the plate feeder has an overall width of 3990 mm and an effective conveying width of 3000 mm, and a length of 24.7 m. However, plate feeder dimensions of any suitable range for the envisaged application may be considered. In particular, for the handling of heavy mineral material, and for example of run of mine material, plate feeders with a working width of 1500 to 4000 mm might be typical.

The apron plate feeder of FIG. 4 is mounted within the mobile feeder apparatus 5 of FIG. 3 as illustrated so that the discharge end is elevated above the receiving end. A large hopper 7 is provided at the receiving end to receive material, for example in batch by batch form from a shovel or the like, for example being run of mine at a working face. This enables the feeder to function as a surge loader, in that material is drawn from the batch by batch loaded hopper in use in a manner that is more generally continuous, and is delivered in a more generally continuous manner to the discharge end.

The inclined apron plate feeder is provided with high side walls to ensure that material is contained and retained on the conveying surface. This is necessary in general operation, and particularly so in inclined operation, to ensure that material does not spread beyond the rigid metal flights of the conveying surface. It is not practical, as it might be on a belt conveyor through appropriate arrangement of the rollers and the more flexible conveying surface, to carry and balance the conveyed material in the middle of the belt.

The feeder apparatus embodiment of FIG. 3 is provided with a volume scanner 80. In the embodiment the volume scanner is positioned towards the discharge end in generally the same location as and above the weighing system 90. Other arrangements may be considered. For example, to monitor truck fill volumes, it may be appropriate to have a volume scanner at or immediately beyond the discharge end. It is necessary for the volume scanner positioned as indicated to be compatible with the high side walls that have been provided to retain material on the plate conveyor. The use of existing volume flow measurement systems that might be known for flexible belt conveyors is not possible with the plate feeder with side walls. The existence of side walls makes volume measurement challenging and may give false readings. The apron plate feeder 100 such as is used in the surge loader apparatus of the FIG. 3 embodiment may carry material right up to and against the sides and there is no mechanism to convey or arrange material flow into the middle section as can be done with a belt conveyor.

These problems are mitigated by the particular combination of the illustrated hardware and of the algorithm that is used to take cognizance of the walls.

The hardware comprises a sensor system 82 carried on a transverse support beam 84 positioned in fixed relationship with the frame of the plate conveyor so as to be located above the conveyor surface and above the height of the side walls. The sensor system is adapted to obtain information relating to the depth of material carried on the conveying surface at multiple points as it passes through the measuring plane and derive an area from these multiple depths.

The sensor system measures a material height at a plurality of points extending transversely across the endless conveyor as material on the conveying surface of the endless conveyor is caused to move through the monitoring plane in use to build up a more accurate picture of area distribution of material.

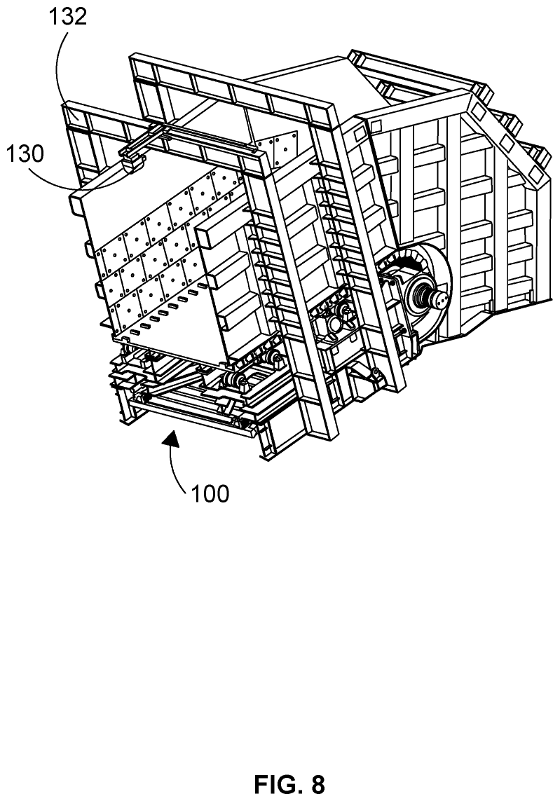

The system comprises in the example embodiment shown in FIG. 8 a single consolidated laser source 130 mounted on the cross bar 132 of a rectangular support frame to sit generally above a longitudinal mid line of the conveying surface and above the height of the relatively high side walls of the feeder. The system is configured to deliver an angular array of laser beams directed downwardly towards the surface, to detect thereby for each beam the distance in a beam direction to a top surface of material on the conveyor surface, and to derive therefrom a material height/depth on the surface at each point where the beam is incident upon a top surface of material.

Such a derivation involves a calculation applying to a determined distance from the beam source to the top of the material at each of the said multiple positions an appropriate for the geometry to obtain a vertical height. An approximation of area may be calculated from these multiple heights, and a measure of volume may be obtained by repeating the determination of such an area successively.

Such an arrangement, with the consolidated laser source arrangement mounted generally above a longitudinal mid line conveying surface deals admirably with the potential problems created by those side walls to conventional sensor arrangements.

In the example embodiment an array of angularly spaced beams is provided every 0.5 degrees in an evenly spaced and symmetrical array and with a spread of up to 180 degrees. Large numbers of height measurements may thus be obtained by appropriate geometric correction to take account of the angular direction of each beam. These may be used to produce a representative area measurement from the multiple height measurements and their positions and a known measure of the width.

A measurement of volume flow is thus obtained first by measuring multiple heights and determining the area of material. This determined area is then multiplied by the speed of the feeder to determine an instantaneous volume flow. Repeated readings may be made to accommodate changes in volume over time.

From a measurement of area, the method of determining volume comprises measuring the depth of material and multiply by the span of that material passing through the measuring plane to determine the material area (ΔA). This determined area (ΔA) is then multiply by the speed of the feeder (S) to determine the volume flow (V) at that point in time in cubic meters.

Volume Flow V=ΔA×S

Cumulative volume flow measurements may be used to obtain an indication of the volume fill level of a truck in a truck fill system such as that illustrated in FIGS. 1 and 2. The volume flow measurement in conjunction with the weighing system described below will also enable measurement to be obtained of the mass per cubic metre that is loaded to each truck. In particular the feeder width is constant, the material depth is measured by the scanning system, the feeder speed is data fed back to the control system continuously, allowing measurement of volume flow for any desired small increment of time. By taking an accumulation of readings, the control system thereby tracks the volume fed to a truck. Each truck may be identified by a readable ID such as a magnetic strip or RFID card. The control system has access to truck capacity data. Therefore every truck is filled accurately to its near precise capacity. This saves the mine money by a substantial increase in efficiency.

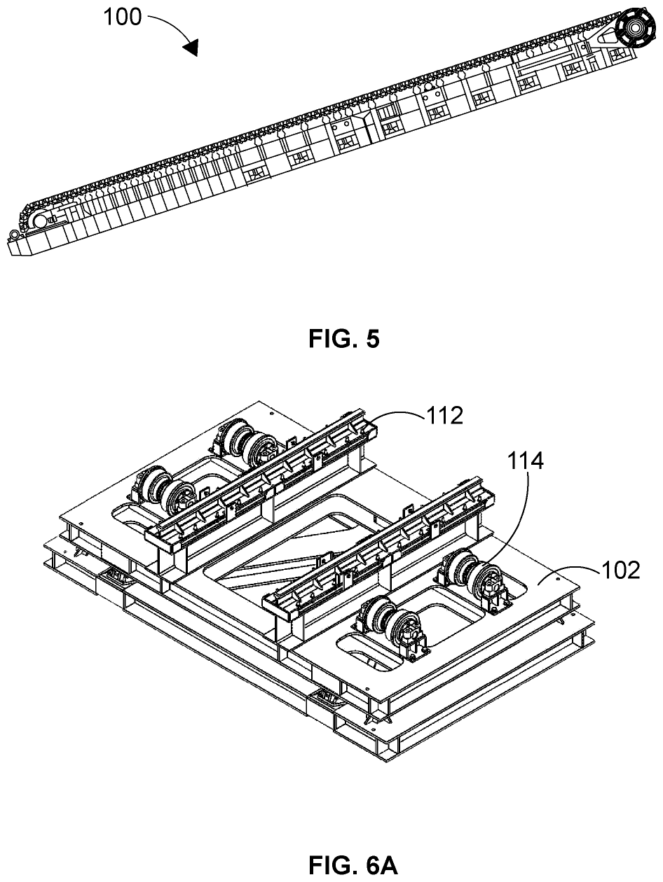

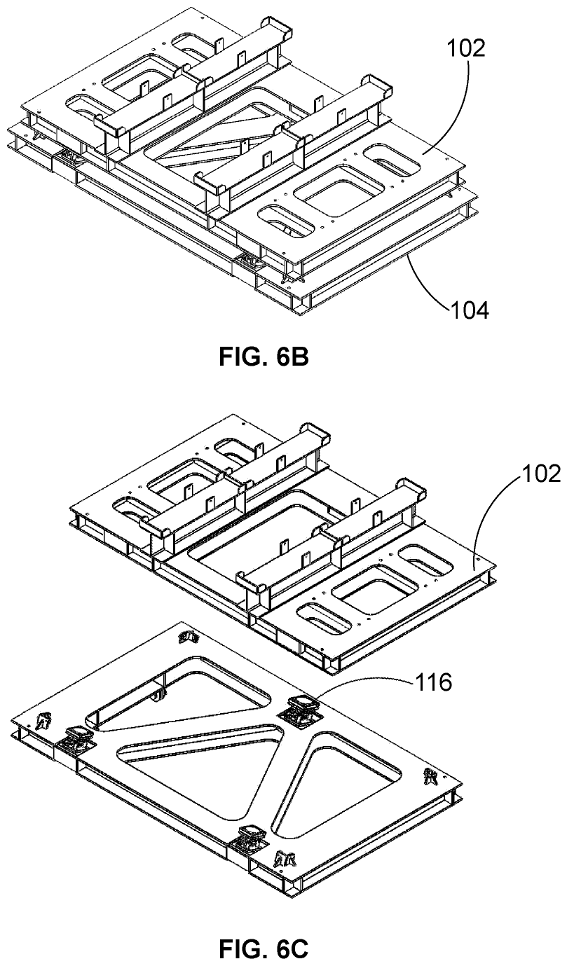

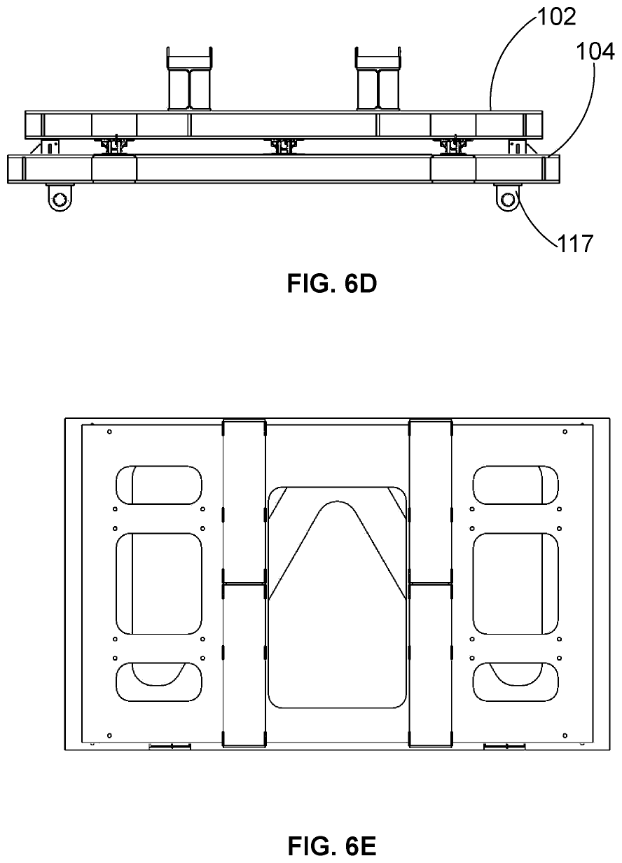

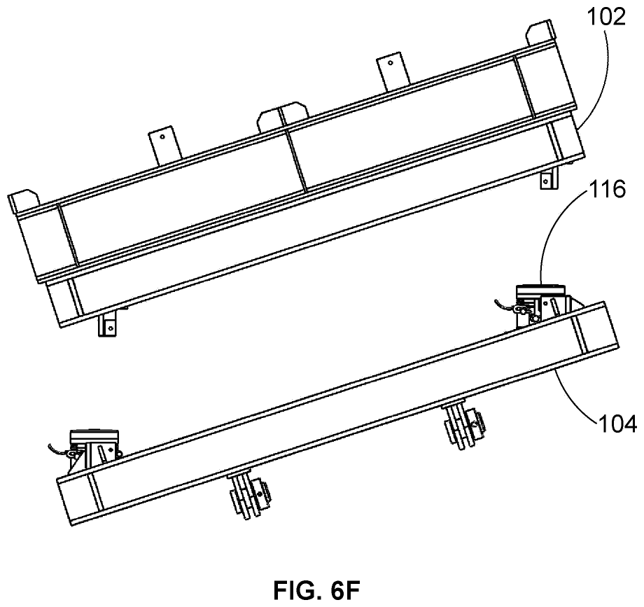

In the embodiment of FIG. 3 a weighing system 90 is also shown located on the plate conveyor towards the discharge end and at a point below the volume scanner. This weighing system is shown in greater detail in FIGS. 5 and 6.

FIG. 5 shows the plate conveyor of FIG. 4 in side elevation in its inclined orientation, with the weighing system visible in situ on an underside of the endless conveyor defined by the successive rolled steel flights, and generally towards the discharge end.

This weighing system is shown progressively disassembled in FIGS. 6A to 6C. The primary functional part, shown most clearly as the lower component in FIG. 6C, is a frame carrying a triangular array of three weight measurement transducers, one carried substantially at each vertex of the triangle. This triangular array of measurement transducers sits directly below the conveying surface of the plate feeder in the weighing zone indicated in FIG. 5 by virtue of the further assembly illustrated in FIGS. 6A and 6B. FIG. 6D shows the assembled whole in end elevation and FIG. 6E in plan view as it would be in situ as shown in FIG. 5.

The distribution of weighing devices in a polygonal array, such as a square or triangular array, and in the embodiment illustrated in a triangular array, attempt to address the particular difficulties associated with weighing material carried on the rigid and robust metal flights of apron plate feeders, which render the techniques that might be applied for other conveyors inapplicable.

Apron plate feeders are a rugged piece of mining equipment for bulk transport of materials, often run of mine material having no other processing other than blasting. They are not precision pieces of engineering. In such cases the product production rate is assessed in terms of mass flow rate per time, (typical tonnes/hour, or Kg/second). This rate is normally measured on a belt weigher. The reading of the load on a conveyor belt is measured through rollers with a means of measurement of the applied load. This is convenient because the conveyor rubber belting is typically light, and the material has also often had some processing, (crushing or sizing) to make it suitable for conveyor transport, and the measurement means is convenient. Such units need not give a high level of accuracy, as their main use is to give a broad assessment of mine production.

The invention concerns the accurate determination of material quantities being handled by the feeder of the first aspect of the invention, especially where used with large, heavy material at the working face, and particularly where used as part of the fully mobile surge loader of FIG. 3 in a truck fill system such as illustrated in FIGS. 1 and 2. In such application the objective is to fill trucks using the fully mobile surge loader, accurately, and quickly, at the mine face.

To fill a truck efficiently, a precise quantity of material is required to be delivered. Fill volume may typically be the most critical parameter but even so to measure and control fill levels accurately both volume and weight considerations may need to be applied. The use of camera technology to measure fill volumes has been suggested, but this is not particularly practical in the harsh environment. Therefore to achieve the goal it is preferable to measure accurately the volume and weight of material delivered by a plate feeder into a truck.

This has many challenges. A plate feeder is wide, in the embodiment 3 m. The material being transported can sit all at one side. The general disposition is random. The plate feeder is elevated and may also, as the surge loader is mobile, have a lateral tilt in use and so sit on an angle in two planes. The weight of material carried is very large, and can be in the typical order of 16 tonne per metre length of the plate feeder. The carrying plates have a long span, and they are made from alloy steel, of some 75 mm thickness, and over 3 m long, they are heavy rugged components. They are not particularly precision.

The carrying plates or flights are supported on a rigid frame, typically made up of long steel beams, and move along suitable engagement means for example comprising an arrangement of rollers and rails carried on the frame with an undersurface of the plates engage to be translatable. It is not easy to include a weighing system in such a rigid structure in such manner as to be able to measure the carried mineral load.

The solution is a weighing frame within the plate feeder with multiple measurement transducers/load measurement cells in a polygonal array, and in the illustrated embodiment a triangular array, which the feeder design does not readily lend itself to.

The weighing frame, best illustrated by the exploded views of FIGS. 6A to 6C in particular, is provided in two parts.

An upper frame portion 102 provides support means on which the plates or flights of the conveyor may be carried when it is in position and along which they may be translated in use. The support and translation means comprise a combination of rollers 114 and rails 112, although it is an advantage of the invention that the upper frame portion 102 may readily be adapted to many support arrangements.

The upper frame portion is shown assembled with a lower frame portion 104 in FIG. 6A, assembled but with the rollers 114 and rails 112 removed in FIG. 6B, and exploded from the lower frame 104 in FIG. 6C.

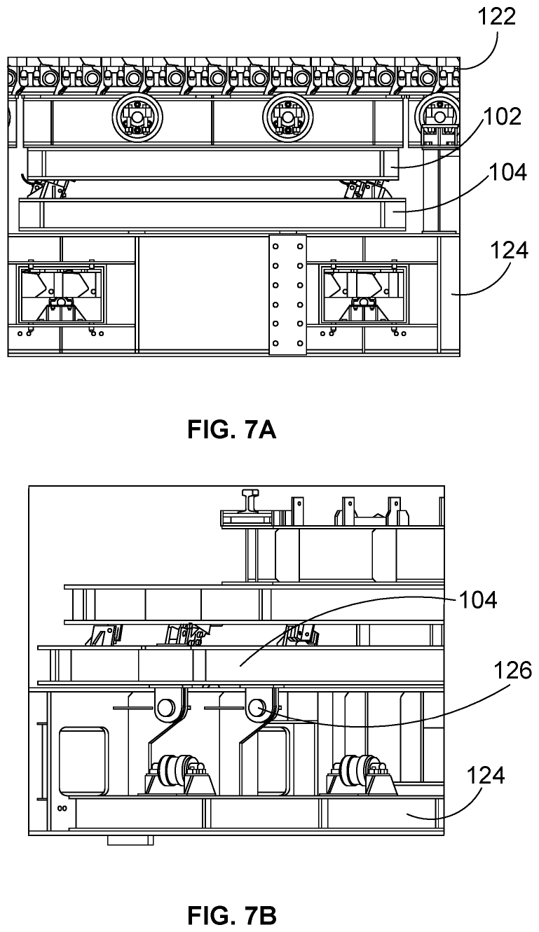

The lower frame portion 104 carries the load cells 116 in a triangular arrangement. The lower frame portion engages with a primary support frame of the plate feeder, for example being bolted onto it (see FIG. 7). When the lower frame portion is so located the rollers 114 form two longitudinal arrays with corresponding rollers on the primary support frame whereby the plates or flights of the conveyor are carried on and with suitable formations on a lower surface engaged with the rollers so as to be translatable relative to the primary support frame and function as a feeder. In the example embodiment, as will be familiar, the two longitudinal series formed by the rollers 114 and identical rollers on the bed of the primary support frame engage drivingly with corresponding drive chains on a lower surface of the endless conveyor and co-operate together to enable suitable drive means to drive the endless conveyor in a continuous manner.

When so located the rails 112 align with corresponding rail formations on the primary support frame to act co-operably as secondary supports for a lower surface of the endless conveyor. In the example embodiment, as will be familiar, the two longitudinal rails do not engage with the lower surface of the endless conveyor in an unloaded state, but are configured to engage the lower surface of the endless conveyor in sliding engagement, in particular in the case where it flexes under load and to limit that flexion.

The upper frame portion 102 is carried on the lower frame portion 104 in such manner that the load carried by the lower frame portion 104 and transmitted through the load cells 116 is the local mass of the upper frame portion 102, associated plates or flights, other structure such as side walls and, when in use carrying material, the mass of the material as well.

The location of the two frame portions in the feeder assembly in the example embodiment is illustrated with reference to FIG. 7A which shows a partial side view and FIG. 7B which shows the attachment of the lower frame portion 104 to the primary support frame of the plate feeder.

Specifically, the lower frame portion 104 is mounted to the primary support frame of the plate feeder 124. The lower frame portion 104 is supported off the main beams of the primary support frame of the feeder via four pin joints 126 which are received via the flanges 117 shown in FIG. 5F. These hold the weighing system around 15 mm clear above the top of the main support beams of the feeder, a limited clearance spacing thus being provided between the lower frame portion and the main beams of the primary support frame. Advantageously, the pin connections of lower frame portion 104 to the primary support frame of the feeder allow the weigh frame to be produced as an individual assembly, and drop it into the primary support frame to be located in a suitably defined receiving space therein. The frame portion 104 is secured with the pins. The upper frame portion sits upon it, contained within the receiving space but not fixed to the primary support frame. The clearance space facilitates the insertion of this module and its removal for example for repair and cleaning. In the alternative, the lower frame portion 104 may seat on the main beams of the primary support frame directly, though it would need some form of securing in position.

The primary support frame and lower frame portion as so assembled define a receiving location for receiving the upper frame portion 102 in position such that the rollers 114 and rails 112 thereon are aligned with complementary and preferably identical rollers and rails on the primary support frame. The load cells are thus in contact with the lower surface of the upper frame portion.

The load cells are relatively incompressible (for example the full range, zero to full load may be less than 0.5 mm). The top frame upper frame portion 102 is enabled to move that small amount restrained by guide means associated with the primary support frame, which are vertical in the nominal working angle of the feeder.

This arrangement allows ready meaningful determination of the weight of material supported upon the conveyor surface in the region of the two plates, as an effective “unladen” measurement at the load cells can be obtained, which is in effect the contribution of the upper frame portion 102, associated plates or flights, other structure such as side walls. Thus, when the system is in use and carrying material, the weight of the material may readily be obtained by subtracting the “unladen” measurement at the load cells from the in-use measurement. An effective measure of the weight of the carried material on the area of the two part frame is obtainable, progressively and in real time.

The two part frame structure is particularly effective as it means the weight of the upper frame, and the plates or flights, other structure such as side walls, and mineral load on the upper frame are all transferred through the load cells. The load that is being measured at the load cells is largely independent of how the mineral is distributed, and uneven distributions and distributions partly supported on or against the side walls can be accommodated in a manner that would not be possible with known belt-based weighing systems.

The embodiment has three load cells 116 in a triangular arrangement. The load cells sit at vertices of a triangular load cell support structure which forms part of a rectangular lower frame portion 104. This creates a three point contact with the upper frame portion 102 through which load may be transferred.

A possible alternative choice would be to fit load cells in four positions but that may lead to instability of the load reading. This problem is illustrated by consideration of a four legged seat which rocks between two stable positions on a hard floor. That is, precision is required to maintain stability with a four point support, where as a three point support will usually stabilise with two points taking the bulk of the load and the third point resolving the unbalance, giving stability with all three points in firm contact, in a situation which has little real precision.

A three point support has a ‘stability triangle’ defined by the three points. This is potentially a disadvantage compared to a four point support, as a single lump of material at one side of the feeder could cause the centre of gravity to move outside the stability triangle. In such a case the apron plate carrying chains may be utilised to re-instate equilibrium and prevent the frame from toppling.

The mounting of the three load measurement cells in the common frame formed by the lower frame portion 104 is thus a preferred compromise to allow reasonable consistency of the reading to be obtained. The load cells arranged as a three point support in a common frame allows for a precision measurement to be taken from a non-precision piece of rugged mining equipment.

The plate feeder is elevated and may also have a lateral tilt in use and so sit on an angle in two planes. In the embodiment, the load cells are mounted enable orientation to be varied relative to the static frame of the feeder to maintain in use an orientation relative to the vertical such that the load to be measured is measured in a vertical orientation rather than normal to the angle of the conveying (that is, will be vertical relative to the ground in use, rather than normal to the general feeder angle). This is illustrated in FIG. 6F, in which the system is tilted, and the position of the load cell modules 116 is adjusted to compensate such that the load being measured remains the load through the cell in a vertical direction.

Horizontal force components are restrained by sliding restraints, in order that they are not restrictive to any deflection displacements within the load frame. It is important that the load cells work through their operating range with very little compression, in order that friction on the horizontal force restraint guides had minimal effect on measurement. A Cosine function is used to correct the load reading for angle, for example taking readings from an inclinometer located on the feeder.

The weighing system may be used co-operably with the volume flow system to get a more accurate picture of the fill process. The feeder's width and the feeder surface height are fixed parameters. The scanning sensing device of the volume system is used to measure the depth and profile of material travelling up the plate feeder. This, in combination with the simultaneous weight reading at the same point, allows a density calculation. In a feedback loop, this allows a precision calculation of volume flow and cumulative volume, which includes variation in density.

The main advantage of the use of a feeder in accordance with the invention is the ability to use the weight and volume flow measurement capabilities to determine truck fill level. Better use of fill capacity is likely to be achievable. Improved automation is likely to be achievable.

This is particularly true in the case of the fully mobile surge loader (FMSL) of FIGS. 3 to 8 applied to a truck load system such as shown in FIGS. 1 and 2. Loading the trucks via FMSL of the discussed embodiment with mobile and surge loading capability offers potential additional and synergistic efficiency advantages for a number of reasons.

The more steady continuous operation allows for the possibility of more even loading, further facilitates the achievement of higher fill levels, and avoids the shock loading effect of dropping 100 t batches into the truck bed. The mobility of the tracked feeder, in conjunction with a mobile tracked shovel, offers in use flexibility. The feeder is drivable on its tracks and pivotable on its chassis allowing it to be positioned optimally to feed the trucks progressively. The mobile arrangement enables a truck to drive alongside the surge output end eliminating the need for it to reverse into position directly adjacent the shovel. This potentially improves truck movement efficiency. A truck need never to reverse into position. It can merely position itself alongside.

In a suitable operating protocol the Fully Mobile Surge Loader (FMSL) will typically be positioned between a mining shovel and the loading point of the trucks.

The FMSL has the following benefits in particular:
Maximise the utilization of mining shovel by allowing it to continue operating in the time periods when there are no trucks available to carry away the material; thereby increasing the overall operational efficiency of the process.
Maximise the effectiveness of the trucks by ensuring a consistent fill level and minimising the time required to fill a truck, as well as reducing truck waiting times.
Improvement of safety by reducing the number of human interactions with heavy machinery.

The FMSL automates filling of mining trucks when they are under the delivery chute of the FMSL. Trucks can approach the FMSL from either of two directions known as the entry and exit. Confirmation of parameters of the truck are determined before the FMSL begins processing material onto the truck. The truck is filled to a predetermined level at which time the loading operation ceases and the driver is signalled to drive away. The FMSL may utilize for example GPS and GNSS (Global Navigation Satellite System) as an enabling technology for mining automation. This system allows the FMSL to carry out propel sequences automatically.

In particular in a possible autonomous mode, the system will automatically run the feeder when a truck is positioned and ready to accept a load. The system will automatically stop the feeder when the truck has been loaded to its target. When the shovel has moved and the FMSL needs to be repositioned, the shovel operator will define its new location via the Shovel System. The FMSL will run the feeder in reverse for one second to move material from the edge of the feeder, then autonomously propel to the location defined by the shovel operator.

The system may include means to recognise and pair the FMSL to a shovel and/or to a truck, for example using RFID detectors and suitable near field communication.

The system may thereby be optimised for fully automated, partly automated or manual truck fill operation.

By way of example in a possible fully automated mode, after a truck is positioned correctly, the feeder will start. Using a target load acquired from the RFID system, the feeder will fill the truck to its target weight, based on an inline weighing scale. Once the target payload has been reached, the system will automatically stop the feeder, then command the truck operator to exit.

The ability to weigh in-line is central to this mode of operation. The load scale on the feeder measures weight as the feeder is running. The measurement point of the weight in the FIG. 3 example embodiment is approximately 3 meters from the discharge end of the feeder. As the feeder runs, software tracks this weight up the feeder and sums the total that is loaded into a truck. When the feeder is stopped, the system retains what is on the feeder to be loaded into the next truck. Additionally, the system allows for the scale to be biased based on hydraulic pressure in the feeder.

The FMSL feeder is equipped with a volumetric system that determines the volume of material that is about to be unloaded. If the system determines that the material volume is greater than the acceptable volume that is defined for that truck type, the system will stop the feeder and signal the truck operator to exit. The volume flow measurement in conjunction with the weighing system enable the user to measure the mass per cubic meter that is loaded to each haul truck.

This combination of measurement of mass flow and volume has not been undertaken in the prior art with run of mine blasted material at the mine face in a plate feeder system. Truck filling has been achieved with accuracy within 4% with this system.

Thus, using a FMSL that embodies the in line weight and volume flow measurement capabilities of the invention provides new and more efficient ways to determine truck fill level, to fill to but not beyond capacity, and to increase automation of the process, all of which are likely to be particularly advantageous when dealing with run of mine material at the working site.

It will be understood that the plate and like hybrid feeders to which the invention relates are typically rugged mining equipment for bulk transport of materials, often run of mine material having no other processing other than blasting. They are not precision pieces of engineering. The skilled person will similarly appreciate that the weighing and volumetric systems envisaged herein are not precision systems, but are systems that can give sufficient accuracy in such materials handling applications as are discussed to offer useful additional information over what is available in the prior art. In the range of such contexts when applied to a plate feeder or to a feeder based on at least some of the principles thereof, including but not limited to mobile systems and including but not limited to the example use in a FMSL concept for truck filling, the in-line weighing and volumetric systems envisaged herein offer potential advantages in that respect over both prior art in-line systems and off-line systems,

1. A feeder comprising:
a feed device having:
a material receiving end for receiving material;
a material discharge end distal of the material receiving end;
an endless conveyor disposed to define a conveying surface between the material receiving end and the discharge end movable in use to cause material received at the material receiving end to be conveyed to the material discharge end,
wherein the endless conveyor comprises a plurality of successively arrayed metal plates, pans or flights;
a material flow monitoring device disposed in association with the feed device and adapted to obtain in use a measurement representative of a quantity of material passing along the conveying surface of the endless conveyor; and
wherein the material flow monitoring device is adapted to obtain a measurement representative of a weight of material passing along the conveyor.

2. The feeder in accordance with claim 1, wherein the flow monitoring device comprises a weighing system disposed below a part of the endless conveyor forming the conveying surface in a fixed relationship with the feeder so as to obtain a measure of weight of material passing over the conveying surface.

3. The feeder in accordance with claim 2, wherein the weighing system is disposed adjacent to a second surface of the endless conveyor opposed to the conveying surface.

4. The feeder in accordance with claim 2, wherein the weighing system comprises an array of weighing devices mounted on a rigid frame.

5. The feeder in accordance with claim 4, wherein the weighing system comprises two frame portions wherein a first frame portion is adapted to engage the second surface of the endless conveyor, and a second frame portion carries the weighing devices disposed on the second frame portion such that a load carried by the first frame portion is transferred through and measurable by the weighing devices in use.

6. The feeder in accordance with claim 5, wherein the second frame portion is mounted on the feeder.

7. The feeder in accordance with claim 6, wherein the second frame portion is mounted to but carried spaced apart from a primary support frame of the feeder.

8. The feeder in accordance with claim 5, wherein first frame portion is seated upon the second frame portion, but is not mounted in fixed manner to the feeder.

9. The feeder in accordance with claim 5, wherein the first frame portion is provided with engagement means so configured as to be functionally continuous with corresponding engagement means on a primary support frame of the feeder such that the endless conveyor engages to be translatable thereon; and the first frame portion is provided with rotational drive engagement formations configured to co-operate with equivalent rotational drive engagement formations on the support frame such that with the weighing system in position the endless conveyor engages to be translatable continuously thereon.

10. The feeder in accordance with claim 4, wherein the weighing devices are arranged in a distributed polygonal array, and for example a triangular array.

11. The feeder in accordance with claim 3, wherein the feeder comprises a processing module adapted to process the measured weight and derive a mass flow numerically therefrom using a known or measured speed of movement of the endless conveyor.

12. The feeder in accordance with claim 1, wherein the material flow monitoring device is adapted to obtain at least two different measurements each representative of a quantity of material passing along the endless conveyor.

13. The feeder in accordance with claim 1, wherein the material flow monitoring device is additionally adapted to obtain a measurement representative of a volume of material passing along the conveyor.

14. The feeder in accordance with claim 13, wherein the measurement representative of volume is a measurement of a secondary parameter comprising a height of material above the surface of the endless conveyor at a plurality of points across the width of the conveyor from which the volume be derived numerically.

15. The feeder in accordance with claim 14, wherein the flow monitoring device comprises a material sensor system comprising one or more height sensors carried in static position with respect to the feed device above the conveying surface on a suitable transverse support so as to define a monitoring plane and so as to measure a material height at a plurality of points extending transversely across the endless conveyor as material on the conveying surface of the endless conveyor is caused to move through the monitoring plane in use.

16. The feeder in accordance with claim 1, comprising:
a chassis supporting the feed device; and
a transport carriage supporting the chassis and adapted to cause the feeder to be movable across a surface for deployment in use.

17. A method for the movement of material from a working site, the system comprising:
providing a feeder preceding positioned to receive material from a work front at a working site;
picking up material from the work front;
transferring material to the material receiving end of the feeder; and
conveying material to the discharge end of the feeder.

18. The method of claim 17, comprising:
providing a material shovel at a work front of the working site;
moving the feeder into position with the material receiving end positioned to receive material from the material shovel;
positioning an onward transport means to receive material from the material discharge end of the feed device;
picking up material from the work front using the bucket of a material shovel;
transferring material from the bucket of the material shovel to the material receiving end; and
conveying material to the discharge end of the feeder and thereby to the onward transport means.

19. The method of claim 18, comprising:
providing a material shovel at a work front of the working site;
moving the feeder into position with the material receiving end positioned to receive material from the material shovel;
positioning a transport truck including a material transport volume to receive material from the material discharge end of the feed device;
picking up material from the work front using the bucket of a material shovel;
transferring material from the bucket of the material shovel to the material receiving end; and
conveying material to the discharge end of the feeder and thereby into the material transport volume of the truck.

20. A system for the movement of material from a working site, the system comprising:
a material shovel having a bucket adapted to pick up material and move the material from a work front;
a feeder positioned to receive material at the material receiving end, for example discharged directly from the bucket or discharged from secondary apparatus to be supplied by material discharged directly from the bucket, and to convey the same to the material discharge end; and
a transport truck including a material transport volume positioned to receive material from the material discharge end of the feed device.
